(19) United States
(12) Patent Application Publication
(10) Pub. No.: US 2009/0154829 A1
(43) Pub. Date: Jun. 18, 2009

(54) METHOD AND APPARATUS FOR EDGE ENHANCEMENT CONSIDERING SINGULAR POINTS

(75) Inventors: Yon-sook Jung, Suwon-si (KR); Bo-gun Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/120,254

(22) Filed: May 14, 2008

(30) Foreign Application Priority Data
Dec. 13, 2007 (KR) 10-2007-0129903

(51) Int. Cl. G06K 9/40

(52) U.S. Cl. 382/266; 382/274

(57) ABSTRACT

A method of and apparatus for edge enhancement considering singular points are provided. The method of edge enhancement includes: determining a first gain from the input image; detecting a singular point distinguishable from an edge from among pixels of the input image; based on the detection result of singular points, determining a second gain for edge enhancement processing; and multiplying the first gain by the second gain to generate a resulting edge-enhanced image.

### CROSS-REFERENCE TO RELATED PATENT APPLICATIONS

This application claims the benefit of Korean Patent Application No. 10-2007-0129903, filed on Dec. 13, 2007, in the Korean Intellectual Property Office, the disclosure of which is incorporated herein in its entirety by reference.

### BACKGROUND OF THE INVENTION

1. Field of the Invention

The present invention relates to an edge enhancement method and apparatus of an image, and more particularly, to a method of and apparatus for enhancing edges of an image.

2. Description of the Related Art

According to conventional image detail enhancement technologies, in order to make an image sharper, the values of pixels output from a high pass filter are multiplied by a gain. In this case, a pixel having a pixel value independent of those of neighboring pixels, such as a white spot on a black background, becomes excessively prominent if the image detail enhancement processing is performed. Also, pulse noise of a plane or mosquito noise which occurs due to a compression results in a pixel which is distinguishable from neighboring pixels, and if image processing is performed to enhance image details, it can be overly emphasized.

FIG. 1 is a diagram illustrating singular points of an image according to conventional technology.

The image illustrated in FIG. 1 is an example of an image having a singular point in which a current pixel has high brightness while neighboring pixels have low brightness. An image of fireworks can be another example. Conversely, an image of a white stone including block spots can also be one having singular points having pixel values independent of those of neighboring pixels. According to the conventional image detail enhancement processing methods or edge enhancement processing methods, a side effect of excessively emphasizing singular points can occur.

In order to prevent the side effect of the image detail enhancement technologies, conventional technology reduces the degree of enhancement for all pixels. Accordingly, in an area desired to increase a gain for image detail enhancement, desired sharpness cannot be obtained.

### SUMMARY OF THE INVENTION

The present invention provides a method of and apparatus for enhancing sharpness only in a desired area by reflecting the characteristic of an image.

The present invention also provides a method of and apparatus for enhancing sharpness, in which an independently existing singular point is detected, and for the pixel detected as a singular point, a different gain for edge enhancement is applied as compared to the case when the singular point is not detected.

The present invention also provides method of and apparatus for determining which of the pixels of the image are singular points.

According to an aspect of the present invention, there is provided a method of edge enhancement by considering a singular point, the method including: determining a first gain from the input image; detecting a singular point distinguishable from an edge from among pixels of the input image; based on the detection result of singular points, determining a second gain for edge enhancement processing; and multiplying the first gain by the second gain and adding the input image to generate a resulting edge-enhanced image.

The determining the first gain of the input image may include: performing in the vertical direction at least one of linear filtering and nonlinear filtering of pixels of the input image; performing in the horizontal direction at least one of linear filtering and nonlinear filtering of pixels of the input image; and adding the vertical filtering result and the horizontal filtering result.

The detecting of the singular point may include: determining the mean brightness value of pixels in the predetermined area including a current pixel of the input image; determining the brightness difference between each pixel in the predetermined area and the current pixel; determining a maximum threshold and a minimum threshold by using the mean brightness value of the pixels in the predetermined area and the brightness difference information with the current pixel; and determining whether or not the current pixel is a singular point, by using the brightness difference, the maximum threshold and the minimum threshold.

The determining of the brightness difference may include: determining the sign of the brightness difference between the current pixel and each pixel in the predetermined area; and determining the absolute value of the brightness difference between the current pixel and each pixel in the predetermined area.

The determining of the maximum threshold and the minimum threshold may include: comparing the number of pixels in the predetermined area, having a positive sign of the brightness difference with the current pixel, with the number of pixels in the predetermined area, having a negative sign of the brightness difference with the current pixel; and according to the comparison result, determining the directions of the maximum threshold and the minimum threshold in the direction in which the number of pixels is greater.

In the determining of the maximum threshold and the minimum threshold, the magnitudes of the maximum threshold and the minimum threshold may be determined differently according to the directions of the maximum threshold and the minimum threshold.

In the determining of the singular point, if the number of pixels from among the pixels of the predetermined area excluding the current pixel, in which the direction of the sign of the brightness difference with the current pixel is the same as the direction of the determined maximum threshold and minimum threshold and the absolute value of the brightness difference with the current pixel is within a range between the maximum threshold and the minimum threshold, is greater than a predetermined number, the current pixel may be determined as a singular point.

The detecting of the singular point may include: determining whether or not the current pixel is an edge of the input image; and if it is determined that the current pixel is an edge, removing the current pixel from the detected singular point.

The determining of the edge may include: calculating a gradient in at least one direction relative to the current pixel; and if at least one absolute value of the calculated gradients is greater than a predetermined number, determining the current pixel as an edge.

In the determining of the second gain, if the current pixel is determined as a singular point, the second gain for the current pixel may be decreased.

According to another aspect of the present invention, there is provided an apparatus for edge enhancement by considering a singular point, the apparatus including: an first gain determination unit determining a first gain from the input image; a singular point detection unit detecting a singular point distinguishable from an edge from among pixels of the input image; a second gain determination unit, based on the detection result of singular points, determining a second gain for edge enhancement processing; and a resulting edge-enhanced image generation unit multiplying the first gain by the second gain and adding the original image to generate a resulting edge-enhanced image.

According to another aspect of the present invention, there is provided a computer readable recording medium having embodied thereon a computer program for the method of edge enhancement considering a singular point.

The method of and apparatus for edge enhancement according to the present invention enhances sharpness of only a desired area by adjusting a gain adaptively to a predetermined pixel of a predetermined area.

Singular points in an image existing independently of neighboring pixels are detected, and for the pixels detected as the singular points, the gain for edge enhancement is adjusted, thereby reflecting the presence of the singular points and enabling edge enhancement adaptive to the characteristic of the image.

Also, even though there is a probability that a pixel is a singular point, if the pixel is included in an edge area, the pixel may not be detected as singular point for edge enhancement and the sharpness of the edge can be enhanced.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating singular points of an image according to conventional technology;

FIG. 2 is a block diagram of an apparatus for edge enhancement considering singular points according to an embodiment of the present invention;

FIG. 3 is a block diagram of a singular point detection unit of an apparatus for edge enhancement considering singular points according to an embodiment of the present invention;

FIGS. 4A and 4B are diagrams illustrating examples of thresholds for detecting singular points according to an embodiment of the present invention;

FIGS. 5A and 5B are diagrams illustrating distribution curves for determining a threshold to detect singular points according to an embodiment of the present invention; and

FIG. 6 is a flowchart illustrating a method of edge enhancement considering singular points according to an embodiment of the present invention.

### DETAILED DESCRIPTION OF THE INVENTION

A method of and apparatus for edge enhancement considering singular points according to the present invention will now be described more fully with reference to the accompanying drawings, in which exemplary embodiments of the invention are shown.

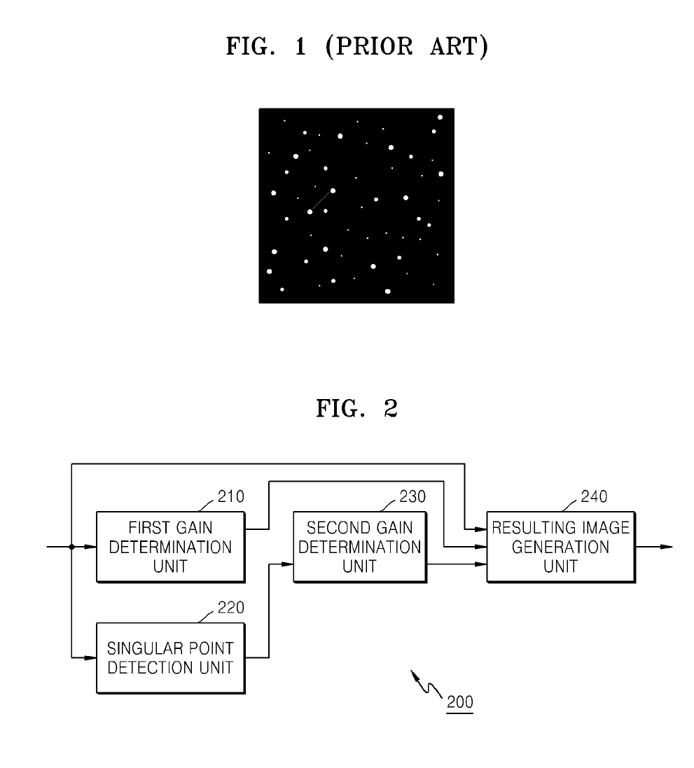

FIG. 2 is a block diagram of an apparatus for edge enhancement considering singular points according to an embodiment of the present invention.

The apparatus for edge enhancement considering singular points according to the current embodiment includes an first gain determination unit 210, a singular point detection unit 220, a second gain determination unit 230, and a resulting image generation unit 240.

The first gain determination unit 210 receives an input of an image in which edges are desired to be enhanced. The first gain determination unit 210 determines first gain to be applied to the input image and outputs the first gain to the resulting image generation unit 240.

An embodiment of the first gain determination unit 210 (not shown) includes at least one of linear filtering and nonlinear filtering of pixels of an input image in the form of a vertical filtering unit which performs the filtering in the vertical direction and a horizontal filtering unit which performs the filtering in the horizontal direction, and a filtering result addition unit which adds the vertical filtering result and the horizontal filtering result to obtain an amount of a first gain that should be applied to the corresponding pixel.

The singular point detection unit 220 receives an input of the image which edges are desired to be enhanced. The singular point detection unit 220 detects a singular point which is distinguishable from an edge and outputs the singular point to the second gain determination unit 230.

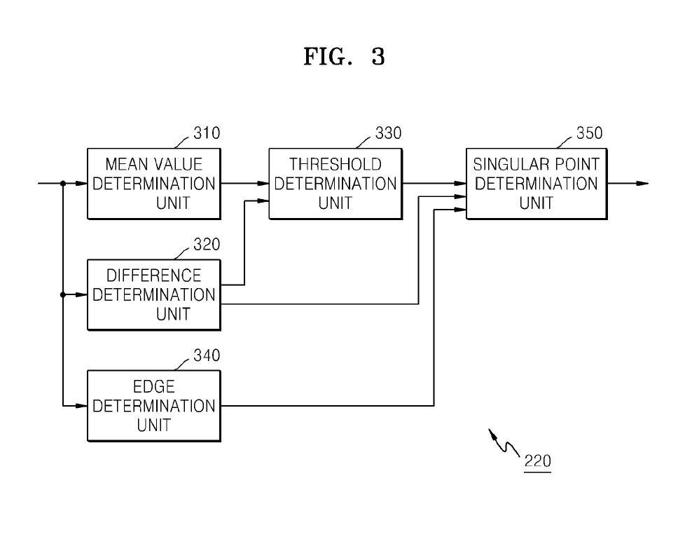

A detailed block diagram of an embodiment of the singular point will be explained later with reference to FIG. 3.

The second gain determination unit 230 receives input of the singular point detection result from the singular point detection unit 220. Based on the detection result of singular points, the second gain determination unit 230 determines the second gain for edge enhancement processing and outputs the second gain to the resulting image generation unit 240.

The second gain determination unit 230 can adjust a gain for edge enhancement processing according to whether or not a current pixel is a singular point. Accordingly, if a current pixel is detected as a singular point in the singular point detection unit, the second gain determination unit 230 may decrease the gain for the current pixel as compared to the case when the current pixel is not detected as a singular point. Preferably, the second gain of a singular point is about 1 or less and the second gain of a non-singular point is about 1 or more.

The resulting image generation unit 240 receives the input image, the first gain from the first gain determination unit 210, and the second gain from the second gain determination unit 230, and generates a resulting edge-enhanced image by multiplying the first gain to the second gain and adding the input image.

FIG. 3 is a block diagram of a singular point detection unit of an apparatus for edge enhancement considering singular points according to an embodiment of the present invention.

The singular point detection unit 220 according to the current embodiment includes a mean value determination unit 310, a difference determination unit 320, a threshold determination unit 330, an edge determination unit 340, and a singular point determination unit 350.

The mean value determination unit 310 determines the mean value of brightness values of pixels in a predetermined area including a current pixel of an input image, and outputs the mean value to the threshold determination unit 330. In an embodiment, the predetermined area may be a block including the current pixel and N×M pixels adjacent to the current pixel, i.e., a block of a size of N pixels in width and M pixels in length.

The difference determination unit 320 receives an input of an image in which edges are desired to be enhanced, and determines the brightness differences between the current pixel and the pixels in the predetermined area of the input image, and outputs the brightness difference information to the threshold determination unit 330 and the singular point determination unit 350.

In an embodiment (not shown) of the difference determination unit 320, the difference determination unit 320 may include a difference sign determination unit for determining the sign of the brightness difference between the current pixel and each pixel in the predetermined area, and an absolute difference value determination unit for determining the absolute value of the brightness difference between the current pixel and each pixel in the predetermined area.

The threshold determination unit 330 receives resulting values from the mean value determination unit 310 and the difference determination unit 320, and determines a maximum threshold and a minimum threshold, by using the mean value of brightness values of the pixels in the predetermined area of the current pixel, and the brightness difference information relative to the current pixel. Accordingly, the maximum threshold information for detecting a singular point is adjusted adaptively to the mean brightness value of a predetermined area including a current pixel.

The threshold determination unit 330 compares the number of pixels in the predetermined area, having a positive sign of the brightness difference with the current pixel, with the number of pixels in the predetermined area, having a negative sign of the brightness difference with the current pixel. The threshold determination unit 330 may determine the directions of the maximum threshold and the minimum threshold in the direction in which the number of pixels is greater.

The threshold determination unit 330 determines the magnitudes of the maximum threshold and the minimum threshold according to the directions of the maximum threshold and the minimum threshold.

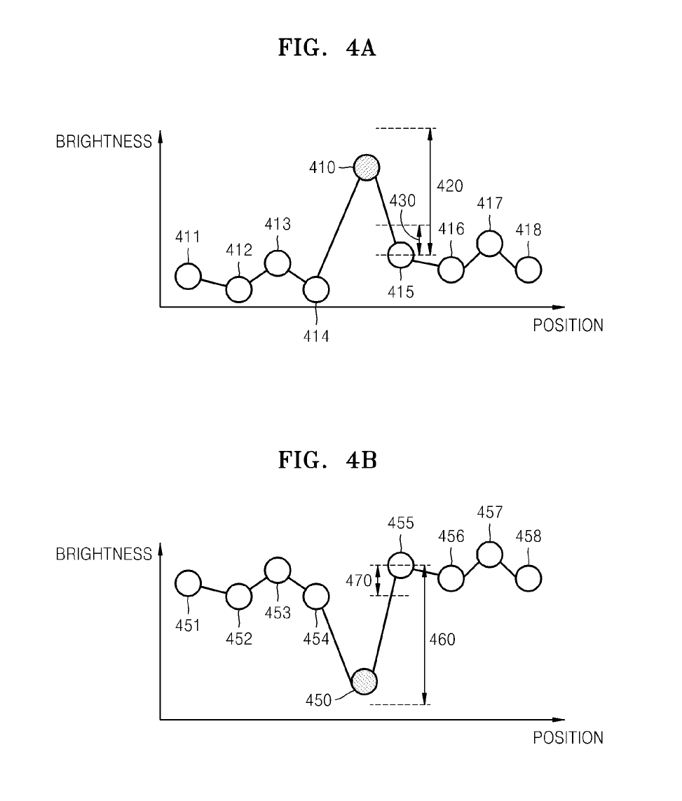

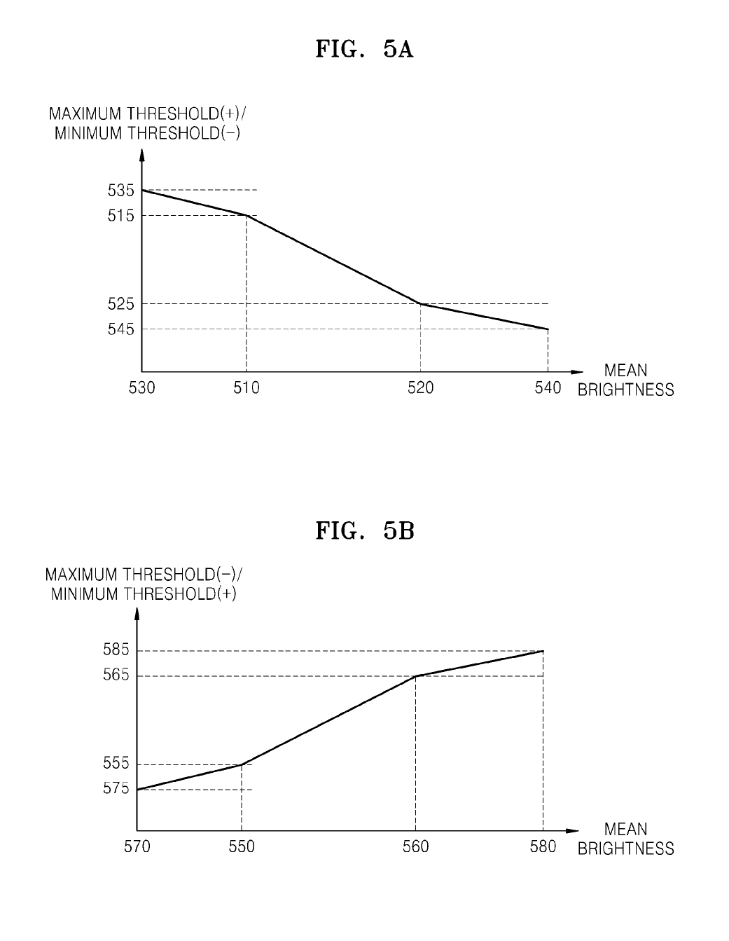

The maximum threshold and the minimum threshold determined in the threshold determination unit 330, and a method of determining a maximum threshold and a minimum threshold will be explained in more detail later with reference to FIGS. 4A and 4B.

The edge determination unit 340 receives an input of an image in which edges are desired to be enhanced, determines whether or not a current pixel is an edge of the input image, and outputs the determination result to the singular point determination unit 350.

In an embodiment (not shown), the edge determination unit 340 may include a gradient calculation unit calculating the gradient in at least one direction in relation to a current pixel. If the absolute value of at least one gradient calculated in the gradient calculation unit is greater than a predetermined number, the edge determination unit 340 determines that the current pixel is an edge. The number compared with the absolute value of the gradient may be adjusted according how strictly the edge determination will be performed.

The singular point determination unit 350 receives brightness difference information from the difference determination unit 320, threshold information from the threshold determination unit 330, and edge information from the edge determination unit 340, and determines whether or not the current pixel is a singular point, by using the brightness difference, the maximum threshold and the minimum threshold. Accordingly, as the singular point determination unit 350 determines whether or not the current pixel is a singular point, the singular point determination unit 350 detects a singular point, and outputs the detection result to the second gain determination unit 230.

According to the current embodiment of the singular point determination unit 350, if the number of pixels from among the pixels of the predetermined area excluding the current pixel, in which the direction of the sign of the brightness difference with the current pixel is the same as the direction of the maximum threshold and the minimum threshold determined in the threshold determination unit 330, and the absolute value of the brightness difference with the current pixel is within a range between the maximum threshold and the minimum threshold determined in the threshold determination unit 330, is greater than a predetermined number, the current pixel is determined as a singular point.

In order to determine a current pixel as a singular point, the predetermined number compared with the number of pixels in which the sign of the brightness difference with the current pixel is the same and the absolute value is within the range may be determined according how strictly the edge determination will be performed.

According to the current embodiment, if it is determined in the edge determination unit 340 that the current pixel is an edge, the singular point determination unit 350 may exclude the current pixel from singular points even though the current pixel satisfies all the singular point requirements. If the current pixel is excluded, in the edge enhancement apparatus 200 considering a singular point, the enhanced degree of an edge enhanced in the first gain determination unit 210 is maintained without change in a pixel which is determined in the edge determination unit 340 to be an edge.

According to the singular point determination unit 350 including the edge determination unit 340, even a pixel having a high probability that the pixel is a singular point may not be detected as a singular point if the pixel corresponds to an edge area, and in this way, the enhanced sharpness of the edge can be maintained.

A method of determining thresholds and a singular point in the singular point determination unit 350 will now be explained in detail with reference to FIGS. 4A and 4B.

According to a method of detecting a singular point according to an embodiment of the present invention, by comparing a current pixel with pixels in a predetermined area including the current pixel, it is examined whether or not the current pixel is a singular point. The current pixel is determined as a singular point when the number of pixels in the predetermined area, in which the sign of the brightness difference with the current pixel is the same and the absolute value of the brightness difference is within the range between the maximum threshold and the minimum threshold, is greater than a predetermined number.

FIGS. 4A and 4B are diagrams illustrating examples of thresholds for detecting singular points according to an embodiment of the present invention.

It is assumed that the direction of the brightness difference between the current pixel and each pixel in the predetermined area is determined in the direction that the brightness of each pixel in the predetermined area is subtracted from the brightness of the current pixel.

The current pixel 410 illustrated in FIG. 4A corresponds to a case where the sign direction of the brightness difference with other pixels 411 through 418 in the predetermined area is positive (+). In this case, the number of pixels in which the sign direction of the brightness difference is positive (+) is greater than the number of pixels in which the sign direction of the brightness difference is negative (−), the sign direction of the maximum threshold and the minimum threshold is determined as (+). Taking for example the pixel 415, it is examined whether or not the brightness of the current pixel is positioned within a range between a brightness value greater by the maximum threshold 420 from the pixel 415 and a brightness value greater by the minimum threshold 430 from the pixel 415.

Accordingly, if the number of pixels, like pixel 415 in which the sign direction of the brightness difference with the current pixel 410 is (+) and the brightness of the current pixel 410 is positioned in a range between a brightness value greater by the maximum threshold 420 from the pixel 415 and a brightness value greater by the minimum threshold 430 from the pixel 415, is greater than a predetermined number, the current pixel 410 is determined as a singular point.

A current pixel 450 illustrated in FIG. 4B corresponds to a case where the sign direction of the brightness difference with other pixels 451 through 458 in the predetermined is negative (−). In this case, the number of pixels in which the sign direction of the brightness difference is (−) is greater than the number of pixels in which the sign direction of the brightness difference is (+), the sign direction of the maximum threshold and the minimum threshold is determined as (−). Accordingly, if the number of pixels, like pixel 455 in which the sign direction of the brightness difference with the current pixel 450 is (−) and the brightness of the current pixel 450 is positioned in a range between a brightness value less by the maximum threshold 460 from the pixel 455 and a brightness value less by the minimum threshold 470 from the pixel 455, is greater than a predetermined number, the current pixel 450 is determined as a singular point.

The maximum threshold, when the sign is (+), may or may not be the same as when the sign is (−). Same is true for the minimum threshold. Also, the absolute values of the maximum threshold and the minimum threshold can be determined adaptively to the mean brightness value of pixels in a predetermined area including a current pixel. A method of determining a maximum threshold and a minimum threshold adaptively to the mean brightness value of pixels in a predetermined area including a current pixel will now be explained in detail with reference to FIGS. 5A and 5B.

FIGS. 5A and 5B are diagrams illustrating distribution curves for determining a threshold to detect singular points according to an embodiment of the present invention.

If the mean brightness value of pixels in a predetermined area including a current pixel is large, the probability that the current pixel is a singular point is higher when the brightness value of the current value is small than when the brightness value of the current value is large. Also, if the mean brightness value of pixels in the predetermined area including the current pixel is small, the probability that the current pixel is a singular point is higher when the brightness value of the current value is large than when the brightness value of the current value is small.

Accordingly, if the mean brightness value of the pixels in the predetermined area of the current pixel is smaller, the sign direction of the maximum threshold and the minimum threshold is (+), and in order to detect, as a singular point, a pixel having a brightness value independent of the mean brightness value of pixels of a predetermined area of a current pixel, the absolute value of the maximum threshold in relation to the singular point is made to be large, and the absolute value of the minimum threshold is made to be small so that the range between the maximum threshold and the minimum threshold can be wide.

Conversely, if the mean brightness value of the pixels in the predetermined area of the current pixel is larger, the sign direction of the maximum threshold and the minimum threshold is (−), and in order to detect, as a singular point, a pixel having a brightness value independent of the mean brightness value of pixels of a predetermined area of a current pixel, the absolute value of the maximum threshold in relation to the singular point is made to be large, and the absolute value of the minimum threshold is made to be small so that the range between the maximum threshold and the minimum threshold can be wide.

Accordingly, referring to a curve illustrated in FIG. 5A, in relation to the distribution of a maximum threshold (hereinafter referred to as a ‘maximum threshold (+)’) in which the direction of the sign is (+), and the absolute value of a minimum threshold (hereinafter referred to as a ‘minimum threshold (−)’) in which the direction of the sign is (−), the absolute values 525 of the maximum threshold (+) and the minimum threshold (−), for a case where the mean brightness value of the pixels in the predetermined area of the current pixel is large 520, is less than the absolute values 515 of the maximum threshold (+) and the minimum threshold (−) for a case where the mean brightness value of the pixels in the predetermined area of the current pixel is small 510.

Likewise, when the mean brightness value of the pixels in the predetermined area of the current pixel is the minimum value 530, the absolute values 535 of the maximum threshold (+) and the minimum threshold (−) are the largest. Also, when the mean brightness value of the pixels in the predetermined area of the current pixel is the maximum value 540, the absolute values 545 of the maximum threshold (+) and the minimum threshold (−) are the smallest. The absolute values of the maximum threshold (+) and the minimum threshold (−) can be determined on the distribution curve between the thresholds 535 and 545.

Since the distributions of the absolute values of the maximum threshold (+) and the minimum threshold (−) show identical shapes, FIG. 5A is referred to together. However, the values may not be completely identical.

Referring to a curve illustrated in FIG. 5B, in relation to the distribution of a maximum threshold (hereinafter referred to as a ‘maximum threshold (−)’) in which the direction of the sign is (−), and the absolute value of a minimum threshold (hereinafter referred to as a ‘minimum threshold (+)’) in which the direction of the sign is (+), the absolute values 565 of the maximum threshold (−) and the minimum threshold (+) for a case where the mean brightness value of the pixels in the predetermined area of the current pixel is large 560 is greater than the absolute values 555 of the maximum threshold (−) and the minimum threshold (+) for a case where the mean brightness value of the pixels in the predetermined area of the current pixel is small 550.

Likewise, when the mean brightness value of the pixels in the predetermined area of the current pixel is the minimum value 570, the absolute values 575 of the maximum threshold (−) and the minimum threshold (+) are the smallest. Also, when the mean brightness value of the pixels in the predetermined area of the current pixel is the maximum value 580, the absolute values 585 of the maximum threshold (−) and the minimum threshold (+) are the largest. The absolute values of the maximum threshold (−) and the minimum threshold (+) can be determined on the distribution curve between the thresholds 575 and 585.

Since the distributions of the absolute values of the maximum threshold (−) and the minimum threshold (+) show identical shapes, FIG. 5B is referred to together. However, the values may not be completely identical.

In one embodiment, the predetermined area may be set to be 7×5 or 11×7 pixels. In the example of 7×5 pixels, the current pixel may be set as a singular point if at least 20 pixels in the predetermined area, in which the sign of the brightness difference with the current pixel is the same and the absolute value of the brightness difference is within the range between the maximum threshold and the minimum threshold. Furthermore in the above example, assuming 10 bit processing (0-1023 levels) and when the mean brightness value is 300 level, the maximum threshold (+), minimum threshold (+) may be set to be 100 level and 8 level respectively; the maximum threshold (−) and the minimum threshold (−) may be set to be 50 level and 20 level respectively. Again in the above example, when the mean brightness value is 800 level, the maximum threshold (+), minimum threshold (+) may be set to be 50 level and 20 level respectively; the maximum threshold (−) and the minimum threshold (−) may be set to be 80 level and 8 level respectively. The direction (+ or −) of the maximum and minimum threshold levels to be applied is decided by comparing the number of pixels in the predetermined area, having a positive sign of the brightness difference with the current pixel, with the number of pixels in the predetermined area, having a negative sign of the brightness difference with the current pixel. The threshold determination unit 330 may determine the directions of the maximum threshold and the minimum threshold in the direction in which the number of pixels is greater.

There may be various other combinations of size of the predetermined area, the number of pixels qualifying (having same sign and the absolute value of the brightness difference from the current pixel is within the range between the maximum and minimum threshold) and the maximum and minimum threshold values for identifying singular points according to the teachings of the present embodiment.

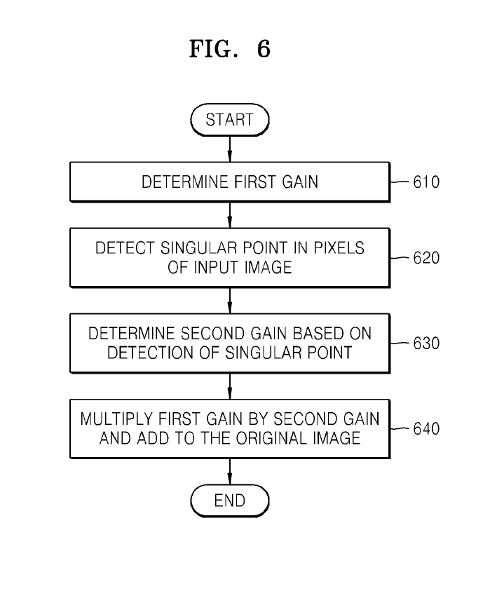

FIG. 6 is a flowchart illustrating a method of edge enhancement considering singular points according to an embodiment of the present invention.

In operation 610, a first gain that should be applied to the input image is determined.

According to the current embodiment, at least one of linear filtering and nonlinear filtering is performed for pixels of an input image in the vertical direction and in the horizontal direction, and the result of the vertical direction filtering and the result of the horizontal direction filtering are added, thereby determining the first gain.

In operation 620, a singular point which is distinguishable from an edge is detected from pixels of the input image.

According to the current embodiment, the mean brightness value of the pixels in a predetermined area including a current pixel of the input image is determined and the brightness difference between the current pixel and each pixel in the predetermined area is determined. By using the mean brightness value of the pixels in the predetermined area and the information on the brightness difference between the current pixel and each pixel in the predetermined area, a maximum threshold and a minimum threshold are determined. By using the determined maximum threshold and the minimum threshold and the brightness difference between the current pixel and each pixel in the predetermined area, it is determined whether the current pixel is a singular point.

Also, it is determined whether the current pixel is an edge of the input image. If it is determined that current pixel is an edge, the current pixel may be removed from consideration as singular points.

In operation 630, based on the singular point detection result, a second gain for edge enhancement processing is determined.

In operation 640, by multiplying the first gain by the second gain and adding the input image, a resulting edge-enhanced image is generated.

According to the current embodiment, the second gain determined by considering whether or not a singular point is detected is multiplied by the first gain, and the result is added to the input image, thereby generating a resulting edge-enhanced image.

The present invention may be implemented by a dedicated hardware or by a programmable microprocessor executed by computer readable codes stored on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

The singular point identification method and system of the present invention is not limited for use with the edge enhancement processing of an input image. That is, once the singular point is identified, there may be other processing that may utilize such information identifying the singular points including but not limited to processing the singular point pixels themselves for image enhancement.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of edge enhancement by considering a singular point, the method comprising:
determining a first gain from the input image;
detecting a singular point distinguishable from an edge from among pixels of the input image;
based on the detection result of singular points, determining a second gain for edge enhancement processing; and
multiplying the determined first gain by the determined second gain; and
adding the result of the multiplication of the first gain by the second gain to the input image to generate a resulting edge-enhanced image.

2. The method of claim 1, wherein the determining the first gain from the input image comprises:
performing in the vertical direction at least one of linear filtering and nonlinear filtering of pixels of the input image;
performing in the horizontal direction at least one of linear filtering and nonlinear filtering of pixels of the input image; and
adding the vertical filtering result and the horizontal filtering result.

3. The method of claim 1, wherein the detecting of the singular point comprises:
determining the mean brightness value of pixels in the predetermined area including a current pixel of the input image;
determining the brightness difference between each pixel in the predetermined area and the current pixel;
determining a maximum threshold and a minimum threshold by using the mean brightness value of the pixels in the predetermined area and the brightness difference information with the current pixel; and
determining whether or not the current pixel is a singular point, by using the brightness difference, the maximum threshold and the minimum threshold.

4. The method of claim 3, wherein the determining of the brightness difference comprises:
determining the sign of the brightness difference between the current pixel and each pixel in the predetermined area; and
determining the absolute value of the brightness difference between the current pixel and each pixel in the predetermined area.

5. The method of claim 1, wherein in the determining of the second gain, if the current pixel is determined as a singular point, the second gain for the current pixel is different as compared to the case when the current pixel is not determined as a singular point.

6. The method of claim 4, wherein the determining of the maximum threshold and the minimum threshold comprises:
comparing the number of pixels in the predetermined area, having a positive sign of the brightness difference with the current pixel, with the number of pixels in the predetermined area, having a negative sign of the brightness difference with the current pixel; and
according to the comparison result, determining the directions of the maximum threshold and the minimum threshold in the direction in which the number of pixels is greater.

7. The method of claim 6, wherein in the determining of the maximum threshold and the minimum threshold, the magnitudes of the maximum threshold and the minimum threshold are determined differently according to the directions of the maximum threshold and the minimum threshold.

8. The method of claim 6, wherein in the determining of the singular point, if the number of pixels from among the pixels of the predetermined area excluding the current pixel, in which the direction of the sign of the brightness difference with the current pixel is the same as the direction of the determined maximum threshold and minimum threshold and the absolute value of the brightness difference with the current pixel is within a range between the maximum threshold and the minimum threshold, is greater than a predetermined number, the current pixel is determined as a singular point.

9. The method of claim 3, wherein the detecting of the singular point comprises:
determining whether or not the current pixel is an edge of the input image; and
if it is determined that the current pixel is an edge, removing the current pixel from the detected singular point.

10. The method of claim 9, wherein the determining of the edge comprises:
calculating a gradient in at least one direction relative to the current pixel; and
if at least one absolute value of the calculated gradients is greater than a predetermined number, determining the current pixel as an edge.

11. The method of claim 5, wherein in the determining of the second gain, if the current pixel is determined as a singular point, the second gain for the current pixel is decreased as compared to the case when the current pixel is not determined as a singular point.

12. The method of claim 11, wherein if the current pixel is determined as a singular point, the second gain is determined to be about 1.

13. An apparatus for edge enhancement by considering a singular point, the apparatus comprising:
an first gain determination unit determining a first gain from the input image;
a singular point detection unit detecting a singular point distinguishable from an edge from among pixels of the input image;
a second gain determination unit, based on the detection result of singular points, determining a second gain for edge enhancement processing; and
a resulting first gain determination unit multiplying the first gain by the second gain and adding the input image to generate a resulting edge-enhanced image.

14. The apparatus of claim 13, wherein the first gain determination unit comprises:
a vertical filtering unit performing in the vertical direction at least one of linear filtering and nonlinear filtering of pixels of the input image;
a horizontal filtering unit performing in the horizontal direction at least one of linear filtering and nonlinear filtering of pixels of the input image; and
a filtering result addition unit adding the vertical filtering result and the horizontal filtering result.

15. The apparatus of claim 13, wherein the singular point detection unit comprises:
a mean value determination unit determining the mean brightness value of pixels in the predetermined area including a current pixel of the input image;
a difference determination unit determining the brightness difference between each pixel in the predetermined area and the current pixel;
a threshold determination unit determining a maximum threshold and a minimum threshold by using the mean brightness value of the pixels in the predetermined area and the brightness difference information with the current pixel; and
a singular point determination unit determining whether or not the current pixel is a singular point, by using the brightness difference, the maximum threshold and the minimum threshold.

16. The apparatus of claim 15, wherein the difference determination unit comprises:
a difference sign determination unit determining the sign of the brightness difference between the current pixel and each pixel in the predetermined area; and
a difference absolute value determination unit determining the absolute value of the brightness difference between the current pixel and each pixel in the predetermined area.

17. The apparatus of claim 13, wherein in the determining of the second gain, if the current pixel is determined as a singular point, the second gain for the current pixel is different as compared to the case when the current pixel is not determined as a singular point.

18. The apparatus of claim 16, wherein the threshold determination unit
compares the number of pixels in the predetermined area, having a positive sign of the brightness difference with the current pixel, with the number of pixels in the predetermined area, having a negative sign of the brightness difference with the current pixel, and according to the comparison result, determines the directions of the maximum threshold and the minimum threshold in the direction in which the number of pixels is greater.

19. The apparatus of claim 18, wherein the threshold determination unit determines the magnitudes of the maximum threshold and the minimum threshold differently according to the directions of the maximum threshold and the minimum threshold.

20. The apparatus of claim 18, wherein if the number of pixels from among the pixels of the predetermined area excluding the current pixel, in which the direction of the sign of the brightness difference with the current pixel is the same as the direction of the determined maximum threshold and minimum threshold and the absolute value of the brightness difference with the current pixel is within a range between the maximum threshold and the minimum threshold, is greater than a predetermined number, the singular point determination unit determines that the current pixel is a singular point.

21. The apparatus of claim 15, wherein the singular point detection unit comprises an edge determination unit determining whether or not the current pixel is an edge of the input image, and if it is determined that the current pixel is an edge, the current pixel is removed from the detected singular point.

22. The apparatus of claim 21, wherein the edge determination unit comprises a gradient calculation unit calculating a gradient in at least one direction relative to the current pixel, and if at least one absolute value of the calculated gradients is greater than a predetermined number, it is determined that the current pixel is an edge.

23. The apparatus of claim 17, wherein if the current pixel is determined as a singular point, the second gain determination unit decreases the gain for the current pixel as compared to the case when the current pixel is not determined as a singular point.

24. The apparatus of claim 23, wherein if the current pixel is determined as a singular point, the second gain is determined to be about 1.

25. A computer readable recording medium having embodied thereon a computer program for the method of edge enhancement considering a singular point of claim 1.

26. A method of detecting a singular point comprises:
determining the mean brightness value of pixels in a predetermined area including a current pixel of an input image;
determining the brightness difference between each pixel in the predetermined area and the current pixel;
determining a maximum threshold and a minimum threshold by using the mean brightness value of the pixels in the predetermined area and the brightness difference information with the current pixel; and
determining whether or not the current pixel is a singular point, by using the brightness difference, the maximum threshold and the minimum threshold.

27. The method of claim 26, wherein the detecting of the singular point comprises:
determining whether or not the current pixel is an edge of the input image; and
if it is determined that the current pixel is an edge, removing the current pixel from the detected singular point.

28. The method of claim 26, wherein the determining of the brightness difference comprises:
determining the sign of the brightness difference between the current pixel and each pixel in the predetermined area; and
determining the absolute value of the brightness difference between the current pixel and each pixel in the predetermined area.

29. The method of claim 28, wherein the determining of the maximum threshold and the minimum threshold comprises:
comparing the number of pixels in the predetermined area, having a positive sign of the brightness difference with the current pixel, with the number of pixels in the predetermined area, having a negative sign of the brightness difference with the current pixel; and
according to the comparison result, determining the directions of the maximum threshold and the minimum threshold in the direction in which the number of pixels is greater.

30. The method of claim 29, wherein in the determining of the maximum threshold and the minimum threshold, the magnitudes of the maximum threshold and the minimum threshold are determined according to the directions of the maximum threshold and the minimum threshold.

31. The method of claim 30, wherein in the determining of the singular point, if the number of pixels from among the pixels of the predetermined area excluding the current pixel, in which the direction of the sign of the brightness difference with the current pixel is the same as the direction of the determined maximum threshold and minimum threshold and the absolute value of the brightness difference with the current pixel is within a range between the maximum threshold and the minimum threshold, is greater than a predetermined number, the current pixel is determined as a singular point.

32. The method of claim 30, wherein the magnitudes of the maximum threshold and the minimum threshold are determined differently according to the directions of the maximum threshold and the minimum threshold.
